(19) United States
(12) Patent Application Publication
(10) Pub. No.: US 2006/0262528 A1
(43) Pub. Date: Nov. 23, 2006

(54) Mobile light

(76) Inventors: Rhoderic Dwight Hall, Temple, GA (US); Karman Monigue Parham, North Port, AL (US); Martressa Nicholette Hall, Douglassville, GA (US); Rosalind Y. Bankhead, Lithia Springs, GA (US)

Correspondence Address: Rhoderick D. Hall, 205 James Allen PL., Temple, GA, 30179, US

(21) Appl. No.: 10/637,778

(22) Filed: May 4, 2005

(51) Int. Cl. B60Q 1/26

(52) U.S. Cl. 362/227

(57) ABSTRACT

The Mobile Safety light is to be used in an emergency situation that one may have while driving. The Mobile Safety light will be placed or stored in a safe location in a vehicle. In times of Vehicle problem the Mobile Safety Light will be employed for operation in less than five minutes. When the Mobile Safety Light is employed its L.E.D. light will inform on coming traffic that there is a disable vehicle ahead and to change lanes for safety.

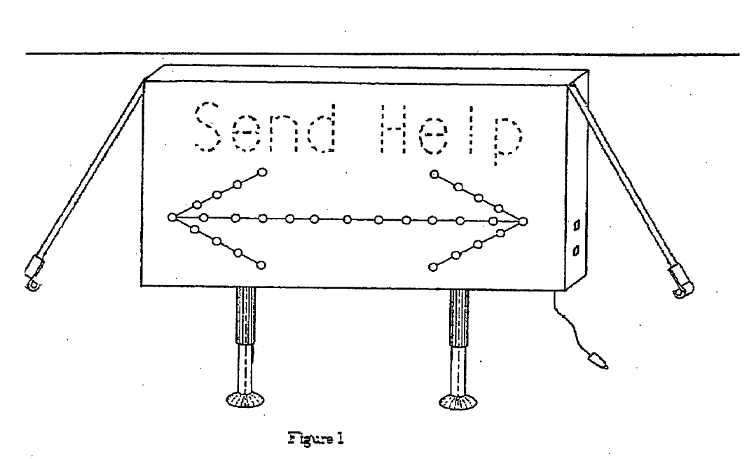

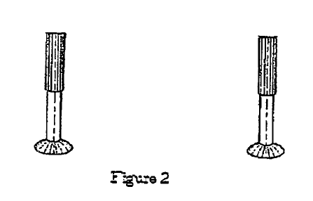

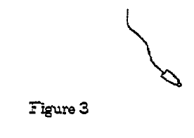

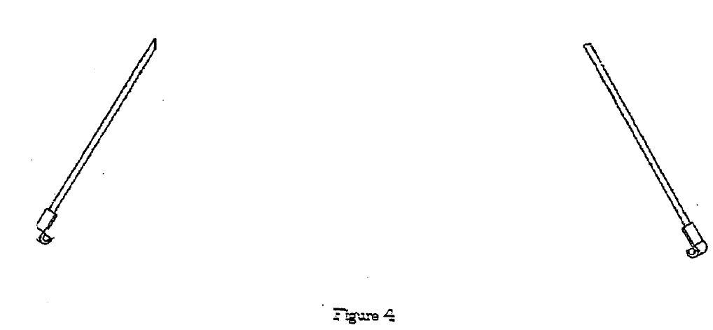

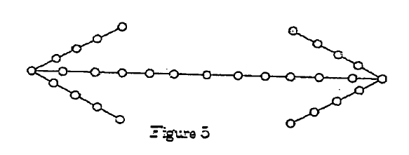

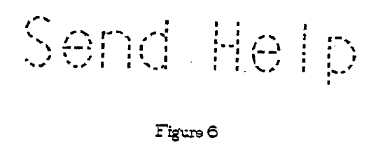

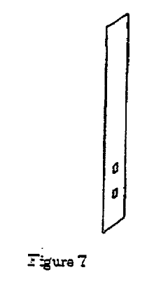

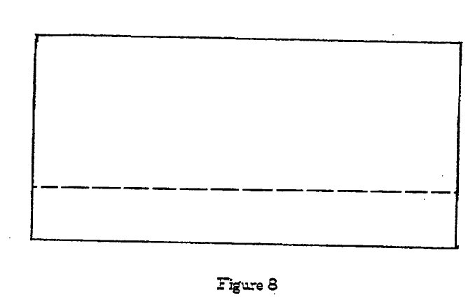

I strongly feel that the invention of the Mobile Safety Light is well over due to the consumer. With the number of accidents on the highways each year, I am very surprised that this product or something similar has not been invented before now. The Mobile Safety Light can be used with any vehicle and anyone.

The Mobile Safety Light is mostly designed for the consumer that is having mechanical vehicular problems or a flat tire. These circumstances would be an ideal time to use the Mobile Safety Light which would warn of vehicular trouble. The Mobile Safety Light will display a visible LED directional arrow to the oncoming traffic. This LED arrow will alert the oncoming traffic that a pedestrian is having problems up ahead. In addition to the directional arrow, the Mobile Safety Light will display a flashing language LED displaying a distress signal. This language is very important to the consumer who does not own a cell phone and/or the consumer who has a cell phone and cannot receive a signal.

Even though every vehicle is equipped with hazard lights, they have proven themselves not to be as effective in saving lives due to the alarming rate of fatalities on the highways today. In my opinion, the Mobile safety Light alone yet also combined with the already existing safety technology will prove to be instrumental in saving lives.

Directional Arrow

This arrow will be used to direct the oncoming traffic to a safer lane. The arrow will be able to go into either left or right direction.

English Language

The primary language for the Mobile Safety Light will be English, however it will have the ability to be changed to your native language. The language will be a flashing LED display.

Elastic Cord

The elastic cord/bungy cord will be used to secure the Mobile Safety Light to the roof or the tire well of any vehicle. The elastic cord/bungy cord will secure the Mobile Safety Light into a steady position.

Suction Cups

The suction cups will protect the paint on your vehicle. The suction cups will add secured stability of the Mobile Safety Light when placed into position

Manual Adjustable Legs

The manual adjustable legs will give the oncoming traffic more time to adjust their speed and to move into another and safer lane. Also, the adjustable legs will give the oncoming traffic the opportunity to see that a vehicle is having problems with their car. If a consumer is having a mechanical problem going down a hill, adjusting the legs to their maxinum height will add more distance for the oncoming traffic to see and therefore adjust the speed at which they are traveling.

LED Display

The LED display will be used to direct the oncoming traffic and will allow the drivers time to adjust their speed. The LED display will also be able to send a verbal message of distress. This is necessary in case there is no access to a phone of any kind.

Power Cord

The Mobile Safety Light will be powered by a power cord that will plug into a cigarette lighter/car adapter outlet. It will also come with a large 6 volt backup battery.

Off/On Button

The off/on button will be used to control the flow of current after the cord has been plugged into the cigarette lighter/car adapter.

Directional Arrow

After placing the Mobile Safety Light onto your vehicle, the consumer will either opt to use the cigarette lighter/car adapter or battery to turn the instrument on. The Directional arrow can be chosen to go into whichever direction that is needed

1. What I claim is my invention is “The Mobile Safety Light”. The Mobile Safety Light is used when one is having vehicular problems on the highway. The language of the Mobile Safety Light will be user friendly for any language/country. The Mobile Safety Light will be displayed by LED (Light Emitting Diodes), to the oncoming traffic to caution them to move into a safe lane.
